(19) United States
(12) Patent Application Publication
(10) Pub. No.: US 2023/0100502 A1
(43) Pub. Date: Mar. 30, 2023

(54) METHOD FOR IMPROVING THE TASTE OF MORINGA SEEDS WHILE RETAINING THEIR NUTRITIVE VALUE

(71) Applicant: IMI TAMI INSTITUTE FOR RESEARCH AND DEVELOPMENT LTD, Kiriyat Ata (IL)

(72) Inventors: Ezra HANUKA, Nesher (IL); Dina ALBA, Yokneam Illit (IL); David FUKS, Haifa (IL)

(21) Appl. No.: 17/910,216

(22) PCT Filed: Mar. 9, 2021
(86) PCT No.: PCT/IL2021/050257

§ 371 Date: Sep. 8, 2022

Related U.S. Application Data
(60) Provisional application No. 62/986,805, filed on Mar. 9, 2020.

(51) Int. Cl. A23L 25/00; A23L 29/30; A23L 29/238; A23L 33/115; A23L 33/185

(52) U.S. Cl. CPC A23L 25/00; A23L 29/30; A23L 29/238; A23L 33/115; A23L 33/185

(57) ABSTRACT

A method for treating Moringa seeds is disclosed. A starting material comprising ground Moringa seeds, preferably seeds that have undergone a process to remove their oil, is contacted with water. The water is drained, and the Moringa seeds are then contacted with water a second time. The product may then be dried or passed to an extruder. The process almost completely removes the unpleasant bitter taste associated with Moringa seeds, but retains most of the protein content of the starting material. In contrast to methods known in the art, the method does not require adjustment of the pH or the use of any organic solvent. A composition comprising ground Moringa seeds that comprises at least 30% protein and has a glucosinolate concentration <10% of that of naturally-occurring Moringa seeds, while lacking the bitter taste associated with raw Moringa seeds, is also disclosed.

### REFERENCE TO RELATED APPLICATIONS

This application claims priority from U.S. Provisional Application No. 62/986,805, filed 9 Mar. 2020.

### FIELD OF THE INVENTION

This invention relates in general to methods for improving the taste of Moringa seeds. In particular, it relates to methods that remove the bitter taste of Moringa seeds due to glucosinolates while retaining a significant portion of the protein content of the untreated seeds.

### BACKGROUND OF THE INVENTION

Moringa is a genus of flowering plants native to parts of western Africa, Madagascar, and southern Asia. Various species of Moringa are known colloquially by names such as “drumstick tree” and “horseradish tree.”

Moringa is widely cultivated, as it tolerates dry conditions, and it has many uses, from traditional medicine to water purification. Moringa is widely regarded as a “superfood,” as many parts of the plant are edible, including the leaves, seed pods, seeds, flowers, and oil derived from the seeds, and the edible parts of the plant are high in protein and other nutrients (Saa, R. W., et al. Food Sci. Nutr. 2019, 7, 1911, henceforth “Saa”). Moringa seed flour has a high protein content (see, for example, Ijarotimi, O. S., et al. Food Sci. Nutr. 2013, 1, 452), and the protein content is not significantly affected by treatments such as boiling or roasting (Mbah, B. O. et al. Pak. J. Nutr. 2012, 11, 211).

Methods of production of a protein extract from Moringa are known in the literature. For example, Jain et al. (Jain, A., et al. J. Food Sci. Technol. 2019, 56, 2093, henceforth “Jain”) have described a method of production of a protein extract from Moringa seeds in which the seeds are first defatted with hexane and then ground to form a flour. The protein is then extracted by an aqueous salt extraction followed by watering-out to precipitate the proteins. It was found that increasing the solvent:flour ratio from 5:1 to 20:1 increased the protein yield, and that the protein yield was optimal when the extraction was performed with a 0.25 M aqueous solution of a salt containing a monovalent cation. The process is also disclosed in Indian Pat. App. No. 3529DEL2014.

Ogunsina and coworkers (Govardhan Singh, R. S.; Ogunsina, B. S.; Radha, C., Ife J. Sci. 2011, 13, 121) used a similar method to extract protein from Moringa seed flour prepared from defatted Moringa seeds. They reported that the protein extraction was optimal when the extracting solvent was an aqueous solution of 0.5 M CaCl₂ at a pH of 4, but that the solvent:flour ratio did not significantly affect the efficiency of the protein extraction.

The popularity of Moringa as a foodstuff is limited, however, by the strong bitter taste of many of the plant's edible parts, particularly the seeds. For example, addition of Moringa seed flour to wheat flour was observed to increase the content of protein and other nutrients, but cakes produced from flour in which 40% of the wheat flour had been substituted were unacceptably bitter (Chinma, C. E., et al., J. Food Process Pres. 2014, 38, 1737, cited in Saa). The bitter taste is believed to be caused by glucosinolates. Reference is now made to FIG. 1, which shows the general glucosinolate structural formula (FIG. 1A) and structural formulas of glucotropaeolin (FIG. 1B), glucosoonjnain (FIG. 1C), and glucomoringin (FIG. 1D), three glucosinolates that are known to occur in Moringa (Fahey, J. E. et al., Sci. Reports 2018, 8, 7994). The glucosinolate structures are shown in the protonated form; in vivo, glucosinolates are essentially entirely ionized, however, due to the strong acidity of the sulfonate group.

Although research has been done on such subjects as the glucosinolate content of wild and domesticated Moringa (see, for example, Chodur, G. M., et al., Sci. Rep.—UK 2018, 8, 7995) and methods for preparing a protein extract from Moringa seeds, surprisingly little effort has been devoted to the development of methods for improving the taste of Moringa by removing or deactivating the glucosinolates while retaining the plant's overall nutritive content.

Ogunsina and Radha have disclosed a non-chemical heat-assisted process for debittering Moringa seeds (Ife J. Technol. 2010, 19, 85). Raw Moringa oleifera kernels are boiled in water (35 minutes on a stove top or 25 minutes in a microwave oven) at a seed to water ratio of 1:30 w/v. The resulting gruel was decanted and the seeds oven-dried at 80° C. for 8 h. The debittered seeds were defatted by washing with hexanes, dried, and milled for use in the preparation of flour. No report was made regarding whether the debittering method improved the taste of the Moringa seeds.

Makkar and Becker have reported (Makkar, H. P. S.; Becker, K., J. Agr. Sci.—Cambridge 1997, 128, 311) that extraction of Moringa seeds with water following defatting by washing petroleum ether lowers the glucosinolate concentration to undetectable levels. The extraction was performed by suspending ground seeds in water at a material:solvent ratio of 1:50 for 20 minutes at 22° C. The authors reported that treatment of Moringa seeds with water significantly affects the distribution of types of proteins in the material.

British Patent No. 440193 describes a method of treatment of grains or oil seeds in general to produce a food for humans or animals. The method consists of swelling the seeds with moisture at a temperature not exceeding 70° C. and then passing them through co-acting, heated, revolving cylinders that thereby dry them and convert them into flakes. There is no specific mention or Moringa or evidence that the method disclosed therein would remove the bitter taste from any bitter starting material.

U.S. Pat. No. 4,315,034 discloses a method for producing a proteinaceous foodstuff from oil seed meals, preferably soybean meal. The method comprises contacting a compacted, defatted seed meal with water at a pH of 2.0-6.5 at elevated temperature and high pressure for a time sufficient to extract non-proteinaceous soluble matter, thereby increasing the protein content while maintaining the structural integrity of the starting material; recovering the product from the aqueous liquor; and drying. No specific mention of Moringa is made.

International (PCT) Pat. Appl. Pub. No. 2016/162246 discloses a method for extracting glucomoringin from Moringa. Glucomoringin was extracted from flour obtained from peeled and defatted Moringa seeds with either a 70% aqueous solution of ethanol at 75-80° C. or with water at 80-90° C. No determination was performed either of the content or of the taste of the Moringa from which the glucomoringin had been extracted.

PCT Pat. Appl. Pub. No. W02018/173041 (henceforth '041) discloses a method for extracting protein from plant matter. The method comprises producing a suspension of the plant matter; extracting protein from the plant matter under basic conditions; acidifying the resulting suspension, preferably to the isoelectric point of the extracted protein, thereby producing a protein/fiber precipitate; and separating the precipitate from the supernatant liquid in order to recover a protein/fiber solid.

Based on the above, it is clear that a more efficient and ecologically friendly method for producing a composition from Moringa seeds that reduces or removes their bitter taste while retaining a significant fraction of the protein content of the seeds, and a Moringa seed composition that is high in protein but lacks the bitter taste of raw Moringa seeds, remains a long-felt, but as yet unmet, need.

### SUMMARY OF THE INVENTION

The present invention is designed to meet this need. The inventors have discovered that the bitter taste of Moringa can be removed while retaining a significant fraction of the protein content by a surprisingly straightforward process: a starting material derived from ground Moringa seeds is washed with water (e.g. tap water), preferably but not necessarily at elevated temperature, filtered, and dried. In preferred embodiments, the starting material is Moringa seed cake from which oil has been at least partially removed, e.g. by cold pressing.

It is therefore an object of this invention to disclose a method for treating Moringa seeds, wherein said method comprises:
obtaining a starting material comprising ground Moringa seeds;
contacting said starting material with a first quantity of water for a first predetermined period of time, thereby producing a soaked Moringa seed material;
separating at least partially said soaked Moringa seed material from said first quantity of water;
contacting said soaked Moringa seed material with a second quantity of water for a second predetermined period of time, thereby producing debittered Moringa seed material; and,
separating at least partially said debittered Moringa seed material from said second quantity of water.

It is a further object of this invention to disclose such a method, wherein said ground Moringa seeds comprise ground dehulled Moringa seeds.

It is a further object of this invention to disclose the method as defined in any of the above, wherein said starting material comprises ground Moringa seeds that have undergone a process to remove at least partially oil from said Moringa seeds. In some preferred embodiments of the method, said starting material comprises milled de-oiled Moringa seed cake.

It is a further object of this invention to disclose the method as defined in any of the above, wherein said step of contacting said starting material with a first quantity of water comprises:
placing said starting material in a vessel;
adding an excess of water to said vessel; and,
allowing said starting material and said first quantity of water to remain in said vessel for said first predetermined period of time.

It is a further object of this invention to disclose the method as defined in any of the above, wherein said step of contacting said starting material with a first quantity of water comprises mixing or stirring said starting material and said water during said first predetermined period of time.

It is a further object of this invention to disclose the method as defined in any of the above, wherein said first predetermined period of time is between 30 and 90 minutes.

It is a further object of this invention to disclose the method as defined in any of the above, wherein said step of contacting said starting material with a first quantity of water comprises contacting said starting material with sufficient water to provide a water:starting material weight ratio of between 3 and 20. In preferred embodiments of the invention, said step of contacting said starting material with a first quantity of water comprises contacting said starting material with sufficient water to provide a water:starting material weight ratio of about 4:1.

In some embodiments of the invention, said step of contacting said starting material with a first quantity of water comprises contacting said starting material with water, the pH of which has been adjusted to be less than 7. In some embodiments of the invention, said step of contacting said starting material with a first quantity of water comprises contacting said starting material with water, the pH of which has been adjusted to be greater than 7.

In some embodiments of the invention, said step of contacting said starting material with a first quantity of water comprises contacting said starting material with room-temperature water. In some embodiments of the invention, said step of contacting said starting material with a first quantity of water comprises contacting said starting material with water the temperature of which is <10° C. In some embodiments of the invention, said step of contacting said starting material with a first quantity of water comprises contacting said starting material with water the temperature of which is between 85° C. and 99° C.

It is a further object of this invention to disclose the method as defined in any of the above, wherein said step of separating at least partially said soaked Moringa seed material from said water is performed by a method selected from the group consisting of filtering, decanting, and centrifuging.

It is a further object of this invention to disclose the method as defined in any of the above, wherein said second predetermined period of time is between 5 and 15 minutes.

It is a further object of this invention to disclose the method as defined in any of the above, wherein said step of contacting said soaked Moringa seed material with a second quantity of water comprises:
placing said soaked Moringa seed material in a vessel;
adding an excess of water to said vessel; and,
allowing said starting material and said first quantity of water to remain in said vessel for said second predetermined period of time.

In some preferred embodiments of the method, said step of contacting said soaked Moringa seed material with said second quantity of water comprises mixing or stirring said soaked Moringa seed material and said water during said second predetermined period of time.

It is a further object of this invention to disclose the method as defined in any of the above, wherein said step of contacting said soaked Moringa with said second quantity of water comprises rinsing said soaked Moringa seed material. In some embodiments of the invention, said step of rinsing said soaked Moringa seed material is preceded by a step of placing said step of placing said soaked Moringa seed material on a filter.

It is a further object of this invention to disclose the method as defined in any of the above, wherein said step of contacting said soaked Moringa seed material with a second quantity of water comprises contacting said soaked Moringa seed material with sufficient water to provide a water:starting material weight ratio of between 3 and 20. In preferred embodiments of the invention, said step of contacting said soaked Moringa seed material with a second quantity of water comprises contacting said soaked Moringa seed material with sufficient water to provide a water:starting material weight ratio of about 4:1.

In some embodiments of the invention, said step of contacting said soaked Moringa seed material with a second quantity of water comprises contacting said soaked Moringa seed material with water, the pH of which has been adjusted to be less than 7. In some embodiments of the invention, said step of contacting said soaked Moringa seed material with a second quantity of water comprises contacting said soaked Moringa seed material with water, the pH of which has been adjusted to be greater than 7.

In some embodiments of the invention, said step of contacting said soaked Moringa seed material with a second quantity of water comprises contacting said soaked Moringa seed material with room-temperature water. In some embodiments of the invention, said step of contacting said soaked Moringa seed material with a second quantity of water comprises contacting said soaked Moringa seed material with water the temperature of which is <10° C. In some embodiments of the invention, said step of contacting said soaked Moringa seed material with a second quantity of water comprises contacting said soaked Moringa seed material with water the temperature of which is between 85° C. and 99° C.

It is a further object of this invention to disclose the method as defined in any of the above, wherein said step of separating at least partially said debittered Moringa seed material from said water is performed by a method selected from the group consisting of filtering, decanting, and centrifuging.

It is a further object of this invention to disclose the method as defined in any of the above, wherein said step of separating at least partially said debittered Moringa seed material from said water is followed by a step of drying said debittered Moringa seed material.

It is a further object of this invention to disclose the method as defined in any of the above, wherein said step of separating at least partially said debittered Moringa seed material from said water is followed by a step of passing said debittered Moringa seed material to an extruder.

It is a further object of this invention to disclose the method as defined in any of the above, wherein said method does not comprise any step requiring use of organic solvent.

It is a further object of this invention to disclose the method as defined in any of the above, wherein said method does not comprise any step of adjusting pH.

It is a further object of this invention to disclose the method as defined in any of the above, wherein said method comprises at least one of:
recovering at least a part of protein present in said first quantity of water following said step of separating at least partially said soaked Moringa seed material from said first quantity of water; and,
recovering at least a part of protein present in said second quantity of water following said step of separating at least partially said debittered Moringa seed material from said second quantity of water; and,
retaining at least a part of said first quantity of water following said step of separating at least partially said soaked Moringa seed material from said first quantity of water; retaining at least a part of said second quantity of water following said step of separating at least partially said debittered Moringa seed material from said second quantity of water; mixing said water obtained in the previous two steps; and, recovering at least a part of protein present in said water obtained in said step of mixing said water obtained in the previous two steps.

In some preferred embodiments of the invention, said step of recovering said protein comprises recovering said protein by ultrafiltration with a suitable membrane; in some particularly preferred embodiments of the invention, said step of ultrafiltration is followed by drying. In some preferred embodiments of the invention, said step of recovering said protein is followed by adding said protein to said debittered Moringa seed material.

It is a further object of this invention to disclose the method as defined in any of the above, wherein said method comprises separating glucosinolates from said water used during said method. It is a further object of this invention to disclose the method as defined in any of the above, wherein said method comprises separating carbohydrates from said water used during said method.

It is a further object of this invention to disclose a composition comprising at least one material selected from the group consisting of ground Moringa seeds, ground germinated Moringa seeds, and ground fermented Moringa seeds, wherein said composition comprises at least 30% protein (w/w) and is characterized by a glucomoringin concentration that is less than 30% (w/w) of that of naturally-occurring Moringa seeds. In some preferred embodiments, said composition is characterized by a glucomoringin concentration that is less than 10% (w/w) of that of naturally-occurring Moringa seeds. In some especially preferred embodiments, said composition is characterized by a glucomoringin concentration that is less than 5% (w/w) of that of naturally-occurring Moringa seeds. In some preferred embodiments, said composition comprises at least 40% protein. In some embodiments, the starting material comprises ground Moringa seeds. In some other embodiments, the starting material comprises ground germinated Moringa seeds. In yet other embodiments, the starting material comprises ground fermented Moringa seeds.

It is a further object of this invention to disclose a composition comprising at least one material selected from the group consisting of ground Moringa seeds, ground germinated Moringa seeds, and ground fermented Moringa seeds, wherein said composition comprises at least 30% protein (w/w) and is characterized by a glucosinolate concentration that is less than 30% (w/w) of that of naturally-occurring Moringa seeds. In some preferred embodiments, said composition is characterized by a glucosinolate concentration that is less than 10% (w/w) of that of naturally-occurring Moringa seeds. In some especially preferred embodiments, said composition is characterized by a glucosinolate concentration that is less than 5% (w/w) of that of naturally-occurring Moringa seeds. In some preferred embodiments, said composition comprises at least 40% protein (w/w). In some embodiments, the starting material comprises ground Moringa seeds. In some other embodiments, the starting material comprises ground germinated Moringa seeds. In yet other embodiments, the starting material comprises ground fermented Moringa seeds. In preferred embodiments of the invention, the starting material has not undergone any process involving contact with organic solvent.

It is a further object of this invention to disclose a composition comprising Moringa seed material derived from a starting material selected from the group consisting of ground Moringa seeds, ground germinated Moringa seeds, and ground fermented Moringa seeds, wherein said composition comprises at least 30% protein (w/w) and is characterized by a glucomoringin concentration that is less than 30% (w/w) of that of said starting material. In some preferred embodiments of the invention, said composition is characterized by a glucomoringin concentration that is less than 10% (w/w) of that of said starting material. In some preferred embodiments of the invention, said composition is characterized by a glucomoringin concentration that is less than 5% (w/w) of that of said starting material. In some preferred embodiments of the invention, said composition comprises at least 40% protein. In some especially preferred embodiments of the invention, said material has not been produced by any process involving contact with organic solvent. In some preferred embodiments of the invention, said composition is characterized by a glucosinolate concentration that is less than 30% (w/w) of that of said starting material. In some preferred embodiments of the invention, said composition is characterized by a glucosinolate concentration that is less than 10% (w/w) of that of said starting material. In some preferred embodiments of the invention, said composition is characterized by a glucosinolate concentration that is less than 5% (w/w) of that of said starting material.

It is a further object of this invention to disclose a composition comprising Moringa seed material derived from a starting material selected from the group consisting of ground Moringa seeds, ground germinated Moringa seeds, and ground fermented Moringa seeds, wherein said composition comprises at least 30% protein (w/w) and is characterized by a glucosinolate concentration that is less than 30% (w/w) of that of said starting material. In some preferred embodiments of the invention, said composition is characterized by a glucosinolate concentration that is less than 10% (w/w) of that of said starting material. In some preferred embodiments of the invention, said composition is characterized by a glucosinolate concentration that is less than 5% (w/w) of that of said starting material. In some preferred embodiments of the invention, said composition comprises at least 40% protein. In some especially preferred embodiments of the invention, wherein said starting material has not been produced by any process involving contact with organic solvent.

It is a further object of this invention to disclose a composition as defined in any of the above, wherein said composition is characterized by at least one of the following:
said composition comprises 30-60% (w/w) protein;
said composition comprises 20-60% (w/w) protein (dry basis);
said composition comprises 0.5-16% (w/w) fat;
said composition comprises 18-55% (w/w) fiber;
said composition comprises 15-40% (w/w) soluble fiber;
said composition comprises 0.5-3.5% (w/w) sugar;
said composition comprises 2-3% (w/w) ash; and,
said composition is characterized by a loss on drying of 1-10% (w/w).

It is a further object of this invention to disclose the composition as defined in any of the above, wherein said composition comprises proteins having molecular weights, as determined by SDS-PAGE electrophoresis with Coomassie staining, of 43.7±1.3 kDa, 32.9±1.0 kDa, 30.4±0.9 kDa, 19.7±0.5 kDa, and 6±1 kDa.

It is a further object of this invention to disclose the composition as defined in any of the above, wherein said composition comprises proteins having molecular weights identical to within one standard deviation of molecular weights of proteins of said starting material, as determined by SDS-PAGE electrophoresis with Coomassie staining.

It is a further object of this invention to disclose the composition as defined in any of the above, wherein said composition is characterized by a bitterness taste value ≤2 on a bitterness scale in which 0 represents no bitter taste at all and 5 represents an extremely bitter taste. In some preferred embodiments of the invention, said composition is characterized by a bitterness taste value ≤1.5 on said bitterness scale. In some preferred embodiments of the invention, said composition is characterized by a bitterness taste value ≤1 on said bitterness scale. In some preferred embodiments of the invention, said starting material is characterized by a bitterness value of at least 4.

It is a further object of this invention to disclose the Moringa seed composition as defined in any of the above, produced according to the method as defined in any of the above.

### BRIEF DESCRIPTION OF THE FIGURES

The invention will now be described with reference to the figures, wherein:

FIG. 1 shows the general glucosinolate structural formula (FIG. 1A) and structural formulas of three typical gluconsinolates: glucotropaeolin (FIG. 1B), glucosoonjnain (FIG. 1C), and glucomoringin (FIG. 1D);

FIG. 2 shows HPLC-MS chromatograms that show the peak corresponding to glucomorinigin in samples of Moringa before and after treatment according to the method disclosed herein; and,

FIG. 3 shows SDS-PAGE electrophoresis gels comparing the protein compositions of raw Moringa seeds and Moringa seed material after treatment by the process disclosed herein.

### DETAILED DESCRIPTION OF THE PREFERRED EMBODIMENTS

In the following description, various aspects of the invention will be described. For the purposes of explanation, specific details are set forth in order to provide a thorough understanding of the invention. It will be apparent to one skilled in the art that there are other embodiments of the invention that differ in details without affecting the essential nature thereof. Therefore, the invention is not limited by that which is illustrated in the figures and described explicitly in the specification, but only as indicated in the accompanying claims, with the proper scope determined only by the broadest interpretation of said claims. In some cases, for clarity or conciseness, individual elements of the invention are discussed separately. Nonetheless, any combination of elements of the invention that is not self-contradictory is considered by the inventors to be within the scope of the invention.

Some embodiments of the invention are described as “comprising” a set of components or method steps, i.e. the scope of the invention may include embodiments that include components or method steps in addition to those explicitly listed. In all cases in which an embodiment is described as “comprising” a set of components or method steps, the scope of invention is to be understood to include embodiments in which the invention “consists of” the listed components or method steps, i.e. embodiments that include the listed components or method steps and no others, and embodiments in which the invention “consists essentially of” the listed components or method steps, i.e. embodiments that do not include any components or method steps not listed that would materially affect the basic and novel characteristics of the invention.

Unless otherwise specified, as used herein, the term “Moringa” is used to refer to any plant of genus Moringa.

Unless otherwise specified, when the term “Moringa seeds” is used generically, it is used to refer to Moringa seeds without reference to the amount or type of processing they may have undergone prior to their treatment by the method disclosed herein. Unless otherwise specified, the term “Moringa seed material” refers to a material made of processed Moringa seeds without specific reference to the processing that they have undergone.

Unless otherwise specified, with reference to numerical quantities, the term “about” refers to a range of ±20% about the nominal value.

Unless otherwise specified, as used herein, the term “excess” with respect to the relative amounts two materials refers to a mass excess.

As used herein, the abbreviation “PP” stands for “polypropylene.”

Unless otherwise specified, as used herein, the term “protein content” refers to the total amount of protein (e.g. percentage by weight) in a sample, without reference to the specific proteins or amino acids present in the sample.

Unless otherwise specified, the terms “defatted” and “de-oiled” used interchangeably to describe Moringa seeds that have undergone a process to remove at least partially their oil or fat content.

Unless otherwise specified, reported protein concentrations are obtained from the amount of nitrogen in the sample as determined by the Kjehldahl method. Total Kjehldahl Nitrogen (TKN) is used as a proxy for protein content, and the reported protein concentrations represent TKN multiplied by a standard constant factor of 6.25.

As used herein, the term “soaked Moringa seed material” refers to Moringa seeds or processed Moringa seeds that have undergone a step of contact with water, whether that step comprises quiescent contact with water or active contact, e.g. contact under conditions of stirring or mixing.

The instant invention provides a novel method for treating Moringa seeds that removes the bitter taste and unpleasant aftertaste of the seeds while retaining most of the protein content that characterizes Moringa. The inventors have discovered, surprisingly, that removal of the bitter taste of Moringa seeds is possible in which the only material used to treat the seeds is water. The novel method does not incorporate any step in which an organic solvent is used, and in preferred embodiments of the invention, the process takes place without any step that requires treatment at a specific pH in particular or under specifically basic or acidic conditions in general.

A novel Moringa seed composition that contains at least 30% protein by weight and from which the bitter taste of unprocessed Moringa seed has been removed is also disclosed herein.

In the description that follows, the process and product are described in terms of the use of Moringa seeds as the starting material. While in some embodiments, Moringa seeds are used, embodiments in which the starting material comprises germinated Moringa seeds and/or fermented Moringa seeds in addition to or instead of Moringa seeds are considered by the inventors to be within the scope of the invention.

In preferred embodiments of the method disclosed herein, ground Moringa seeds are used in the starting material, as they provide better results than whole Moringa seeds. In more preferred embodiments of the method, the Moringa seeds are dehulled prior to grinding. In particularly preferred embodiments of the invention, the starting material comprises ground Moringa seeds that have undergone a process that extracts at least part of their oil (“defatted Moringa seeds”). A non-limiting embodiment of such a process is cold pressing. In preferred embodiments of the invention in which the starting material comprises defatted Moringa seeds, the process of defatting does not involve the use of any organic solvent. The oil itself is tasteless, and the starting material retains the bitter taste of untreated Moringa seeds; thus, it is not essential to remove all of the oil. In preferred embodiments of the invention, the starting material is ground Moringa seed cake made from seed material that remains after commercial oil extraction, i.e. after all of the oil that can be extracted economically has been removed.

The starting material is contacted with water, e.g. by placing the starting material in an appropriate receptacle, adding water, and allowing the seeds to soak for a predetermined length of time, preferably with stirring. Any source of water appropriate for use with food may be used. A non-limiting example is tap water. In typical embodiments of the invention, sufficient water is added to create a slurry. In preferred embodiments of the invention, water is added to the starting material in a volume ratio of between 2:1 and 20:1. In especially preferred embodiments of the invention, water is added to the starting material in a volume ratio of about 4:1. In some embodiments of the invention, the water is at room temperature (typically about 20-25° C.). In some embodiments of the invention, cold water, typically at a temperature of less than 10° C. and preferably at a temperature of about 4° C., is used. In some embodiments of the invention, warm water, typically at a temperature of about 40° C., is used. In some embodiments of the invention, hot water, typically at a temperature between 88° C. and 97° C. and preferably at a temperature of between 90° C. and 93° C., is used.

In preferred embodiments of the invention, the step of contacting the starting material with excess water is performed by adding the water to the starting material in an appropriate receptacle and then mixing continuously for 30-90 minutes.

After the starting material has contacted the water, the soaked Moringa seed material is separated from the water. Any method known in the art can be used to separate the water from the soaked Moringa seed material; non-limiting examples include filtration, decanting, and centrifuging. The separation need not be complete; in typical embodiments of the invention, the soaked Moringa seed material is still wet after the water has been separated.

In preferred embodiments of the invention, after separation of the water from the soaked Moringa seed material, the soaked Moringa seed material is then contacted a second time with water. In particularly preferred embodiments of the invention, an excess of water is used in this step as well. As in the first step of contact with water, any source of water suitable for use with food can be used. The second contact is generally shorter than the first one, and in typical embodiments comprises adding an excess of water to the soaked Moringa seed material and then mixing for 5-10 minutes. In some embodiments of the invention, the second contact comprises rinsing the Moringa seed material on an appropriate filter.

In some embodiments of the invention, after the second contact with water, the soaked Moringa seed material is dried, typically to a final water content of less than 8% by weight. In other embodiments of the invention, following the second contact with water, the soaked Moringa seed material is passed directly to an extruder. The extruded material can then be processed according to any method known in the art.

In preferred embodiments of the invention, the steps of contacting the Moringa seed material with water are performed using water as received from its source, i.e. at a pH of 7 and without any additives or processing. In some embodiments of the invention, at least one of the steps of contacting the starting material with water is performed under acidic or basic conditions, i.e. the pH of the water is adjusted prior to its contact with the Moringa seeds by addition of an acid or base that is compatible with and approved for use in food processing prior to the step of contact with the Moringa seed material. When neutral water is used in the steps of contacting the Moringa seed material with water, the pH of the supernatant liquid typically equilibrates at a value of 5-5.5. Thus, in some embodiments of the invention, at least one of the steps of contacting the Moringa seed material with water comprises contacting the Moringa seed material with water until the supernatant liquid has reached a pH of between 5 and 5.5.

While the method disclosed herein includes within its scope embodiments in which at least one of the steps of contacting the Moringa seed material is performed under acidic or basic conditions, it is emphasized that in contrast to methods known in the art (e.g. the method disclosed in '041), the method disclosed herein does not require any use of organic solvent or any step of pH adjustment at any point in the process; methods of protein extraction known in the art, such as the one disclosed in '041, require extraction of the protein under basic conditions followed by lowering of the pH to the protein's isoelectric point. Jain has shown that the extractability of protein from Moringa is not strongly pH-dependent. Without being bound by theory, it appears that not only is there no single pH at which the extraction of the protein from the raw starting material is most efficiently performed, but there is also no single isoelectric point that characterizes the Moringa proteins that would require adjustment of the pH in order to increase the efficiency of the separation of the proteinaceous material. As can be seen from the non-limiting examples presented below, contact and rinsing with water is sufficient to improve significantly the taste of Moringa, and in typical embodiments of the invention, approximately 50% of the protein of the Moringa starting material is retained in the product, independent of the pH to which the water is adjusted.

As the non-limiting examples given below demonstrate, not only does the method disclosed herein yield a product that has a protein content similar to that of the starting material, it also produces a product that is significantly more palatable than the starting material. As was explained above, it is widely believed that the bitter taste of Moringa is due to naturally-occurring glucosinolates. In order to assess the ability of the method disclosed herein to remove glucosinolates, HPLC-MS analyses were performed of a sample of Moringa as received and after treatment by the method disclosed herein. A milled defatted Moringa seed cake was treated according to the method disclosed herein, with the steps of contacting the Moringa with water performed using cold (˜4° C.) water. The analysis was performed with an Agilent Technologies Model 6550 Q-TOF LC/MS system. MS detection was performed with an ESI interface in negative mode, and LC detection with an Agilent Model 1290 UV detector operating at a detection wavelength of 229 nm. A KROMASIL 100-5-C18 250 mm×2.1 mm×5 μm column was used; the column temperature was 25° C., the sample temperature 20° C., and the flow rate of the mobile phase (acetonitrile/H₂O+20 mM ammonium formate, run in gradient mode from 2% acetonitrile at t=0 to 50% acetonitrile from 30-40 min and then to 2% acetonitrile at t=42 min) was 0.3 ml/min.

Samples of the starting material and product of the process were prepared by placing ˜0.5 gin a 250 ml glass bottle, inserting a magnetic stirrer, adding 50 ml distilled water, mixing, and adding 50 ml methanol. The bottle was placed in a 70° C. oil bath and the contents stirred for 15 minutes. The sample was then removed from the oil bath and cooled for 10-15 min until undissolved material had precipitated. 1 ml of the supernatant was filtered through an 0.2 μm PTFE syringe filter, and 0.5 ml of the filtrate diluted with 0.5 ml of a 1:1 (v/v) water/methanol mixture. Following the completion of the treatment of the Moringa seeds, samples of the water that had been used to contact the Moringa seed material were prepared by adding 10 ml methanol to a ˜10 ml sample along with a magnetic stirrer. The sample was placed in a 70° C. oil bath and stirred for 15 minutes. The sample was then removed from the oil bath and cooled for 10-15 min until undissolved material had precipitated. 1 ml of the supernatant was filtered through an 0.2 μM PTFE syringe filter, and 0.06 ml of the filtrate diluted with 0.94 ml of a 1:1 (v/v) water/methanol mixture to produce a 33-fold dilution of the process liquid.

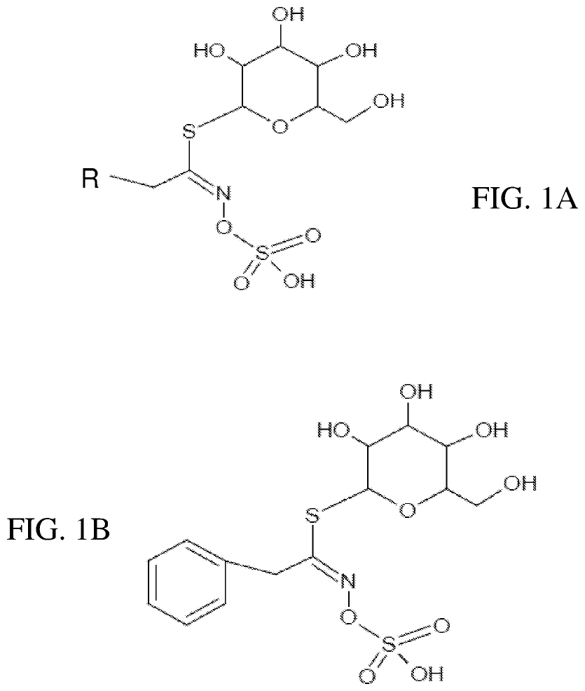

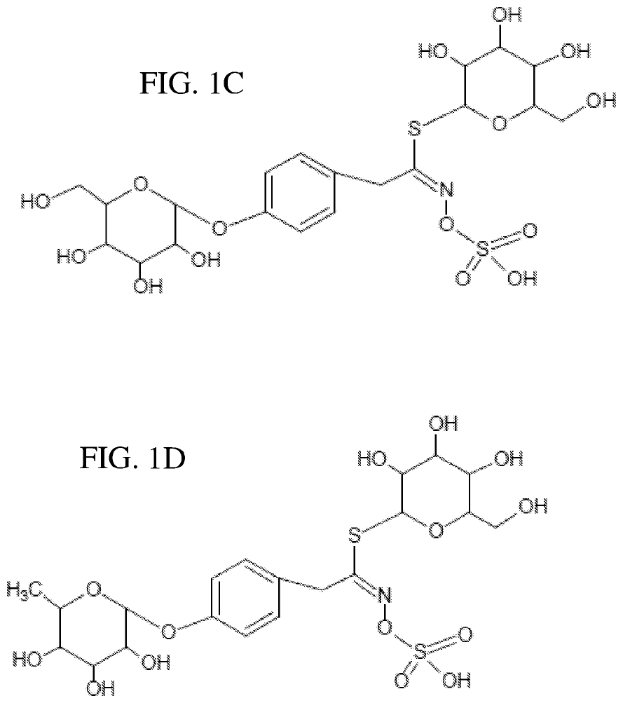

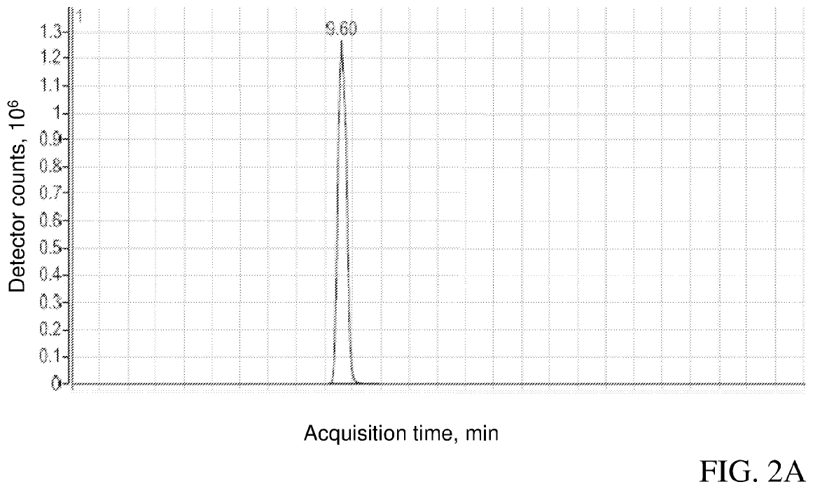

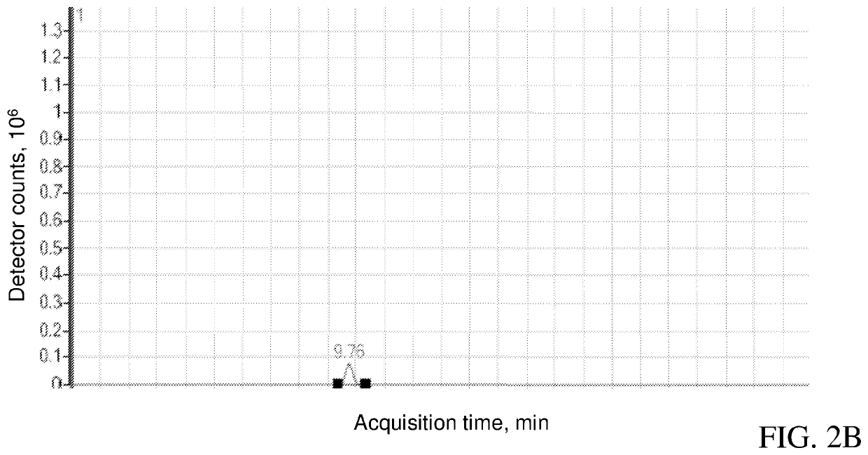

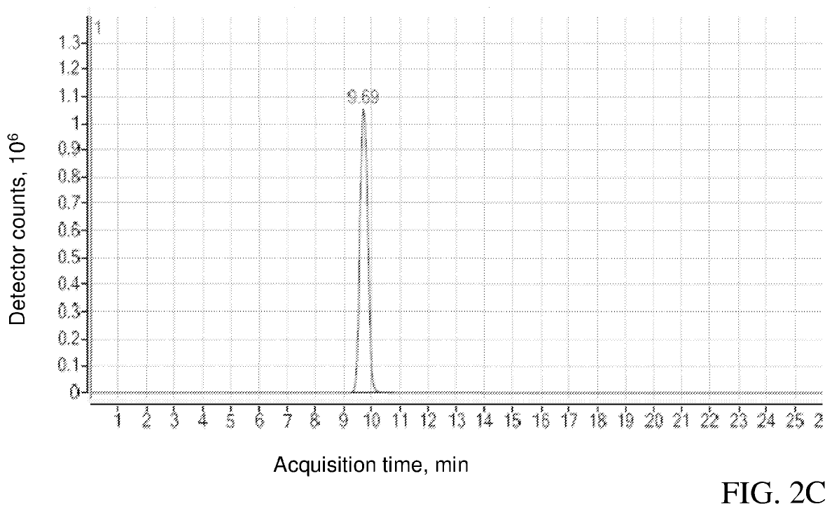

Reference is now made to FIG. 2, which shows LC chromatograms corresponding to the MS peak at 570 Da, assigned to the [M-H]⁻ peak of glucomoringin (FIG. 1D; MW=571). FIG. 2A shows the chromatogram of the starting material, FIG. 2B the chromatogram of the product of the treatment, and FIG. 2C the water used to contact the Moringa seed material, obtained following the conclusion of the treatment. As is clear from the chromatograms, the process disclosed herein removes >95% of the glucomoringin from the Moringa seeds, and transfers it to the water used to contact the Moringa seed material.

It is within the scope of the invention to disclose a Moringa seed composition that has a high protein content but that is considerably less bitter than unprocessed Moringa seeds. The Moringa seed composition includes no ingredients other than processed Moringa seeds and contains at least 30% protein by weight; in preferred embodiments, the composition contains at least 40% protein by weight. In some embodiments, the composition contains between 30% and 60% protein by weight. The composition is characterized by a glucosinolate concentration that is less than 10%, and in preferred embodiments, less than 5% of the glucosinolate concentration of the starting material, e.g. unprocessed (naturally occurring) Moringa seeds. In some embodiments, the composition comprises 0.5-16% fat by weight. In some embodiments, the composition comprises about 50% fiber by weight. In preferred embodiments, the composition comprises 15%-40% by weight soluble fiber and about 15% by weight insoluble fiber. In some embodiments, the composition comprises 0.5-3.5% sugar by weight. In some embodiments, the composition comprises 2-3% ash by weight. In some embodiments, the composition comprises 1-10% moisture by weight.

In preferred embodiments, the composition comprises Moringa seeds from which at least part of the oil has been extracted, preferably by a method that does not involve any contact of the Moringa seeds with organic solvent. As shown in the examples below, the composition is highly palatable. In typical embodiments, it has a bitterness of ≤2.5 on a scale in which 0 represents no taste at all and 5 represents extremely bitter. In preferred embodiments, it has a bitterness of ≤2. In more preferred embodiments, it has a bitterness of ≤1. In preferred embodiments, the composition is produced by the process disclosed herein.

After the completion of the treatment of the Moringa seeds, the water used in the treatment retains useful material such as extracted protein and glucosinolates that can be separated and recovered. As a non-limiting example, the protein can be recovered by ultrafiltration with a suitable membrane and then drying, e.g. on a spray dryer. The recovered protein can be used separately, or added to the product to increase its protein concentration. The glucosinolates and carbohydrates extracted from the Moringa seeds do not appear to degrade or decompose, and can also be separated from the water for further use.

The following examples are presented to assist a person of ordinary skill in the art to make and use the invention herein disclosed, and are not intended to be limiting in any way. In the examples, the seeds used in all cases were from Moringa oleifera. In cases in which the amounts of components are given as ranges, each range represents the range of results of independent analyses of the compositions a plurality of different samples. In cases in which more than result is reported in a given table, each result represents an independent experimental run.

Determination of the level of bitterness of samples was performed by a blind taste test in which unmarked samples were given to each member of a group of six individuals to taste. The members of the group rinsed their mouths with water following the tasting, and in cases in which the sample was judged to be extremely bitter, the next sample was not tasted until after the bitter taste had completely gone away. In some of the examples, the taste was rated on a scale of 0-5, in which 0 represents no bitter taste at all and 5 represents extremely bitter.

### EXAMPLE 1

A sample of Moringa seeds was treated according to the method of Ogunsina and Radha. The Moringa seeds were then tasted and found to be extremely bitter.

### EXAMPLE 2

A sample of defatted milled Moringa seeds as obtained. The starting material was analyzed and found to contain approximately 50% protein, 25% fiber, 10% fat, and 2% sugar by weight.

1.9 kg of the starting material was mixed with 7.7 kg tap water that had been heated to ˜93° C. The resulting slurry was had a pH of —5.4. The slurry was mixed in a stirrer for 45 minutes under heating to 93-98° C. The slurry was then filtered on a 20 μm PP filter cloth. An additional 7.7 kg of tap water that had been heated to ˜92° C. was added to the wet solids and stirred for an additional 5-10 minutes followed by filtration. The resulting wet cake, weighing ˜3.6 kg, was dried in a vacuum oven dryer at 70° C. and a pressure of 20-50 mbar.

The dry product weighed ˜1 kg and was found to contain approximately 39% protein, 53% fiber, 1.5% fat, and 1.5% sugar, with improved taste.

### EXAMPLE 3

Moringa seeds milled after oil extraction were obtained. The milled seeds were analyzed and found to contain ˜50% protein, ˜25% fiber, and ˜10% fat.

1 kg of the Moringa seeds was mixed with 4 kg of cold tap water (˜4° C.). A sufficient quantity of a 10% (w/v) aqueous solution of NaOH was added to raise the pH to 9. The mixture was kept at 4° C. for 15 minutes under continuous mixing. A sufficient quantity of an 8% (w/v) aqueous solution of HCl was added to lower the pH to 4. The mixture was then kept at 4° C. for 1 hour under continuous mixing, followed by filtration on a 20 μm PP filter cloth. 4 kg of room-temperature tap water was added to the wet solids retained after filtration, and the resulting slurry mixed for an additional hour followed by filtration. The wet solids remaining after the second filtration were then dried in a vacuum oven at 70° C. under a pressure of 20-50 mbar. After drying, ˜0.45 kg of a dry powder was obtained.

The powder contained ˜36% protein by weight, and had an improved taste relative to the starting material.

### EXAMPLE 4

Milled Moringa seeds containing 45-55% proteins, 4-13% fat, 15-22% soluble fiber, 8-14% insoluble fiber, 3.5-7% sugar, 4-6% ash, and 6-9% moisture were obtained.

1 kg of the milled seed cake was mixed with 4 kg room temperature tap water. A sufficient quantity of a 10% (w/v) aqueous NaOH solution was added to raise the pH to 9. The mixture was mixed at room temperature for 15 minutes. A sufficient quantity of an 8% (w/v) aqueous HCl solution to lower the pH to 4 was then added. The resulting mixture was then mixed for 1 hour at room temperature, followed by filtration on a PP filter cloth. The wet solids retained after filtration were washed with additional tap water, and then dried in a vacuum drying oven at 70° C. and a pressure of 20-25 mbar. After drying, ˜0.45 of a dry powder was obtained.

The powder contained by weight 30-45% protein, 0.5-1.5% fat, 35-40% soluble fiber, 15% insoluble fiber, 0.5-2% sugar, 2-3% ash, and 3-7% moisture. The bitter taste of the starting material was not present in the product.

### EXAMPLE 5

1.9 kg of Moringa seeds obtained from plants grown in Israel, milled after oil extraction, were used as a starting material. The seeds were determined to contain ˜50% protein, ˜25% fiber, and ˜10% fat. The Moringa seeds were mixed with 7.7 kg of hot (˜93° C.) tap water to form a mixture having a pH of ˜5.4. The mixture was stirred for 45 minutes while the temperature was maintained at 93-98° C. The mixture was then filtered on a 20 μm filter cloth. And additional 7.7 kg of hot (92° C.) tap water was added to the wet solids remaining after filtration to form a slurry and stirred for an additional 5-10 minutes. The slurry was filtered, yielding ˜3.6 kg of wet cake, which was dried in a vacuum oven at 70° C. and a pressure of 20-50 mbar. After drying, ˜1 kg of a dry powder was obtained.

The powder contained ˜47% by weight protein, and had an improved taste relative to the starting material.

### EXAMPLE 6

A number of tests were made in which raw Moringa seeds were washed with organic solvents and then dried as described above. Results of the tests are summarized in Tables 1 and 2.

TABLE 1

| Material | Total protein, % | Taste |
|---|---|---|
| Raw moringa seed | 45.5 | 4 |
| Moringa seed after ethanol wash | 54.4 | 5 |

TABLE 2

| Material | Total protein, % | Taste |
|---|---|---|
| Raw moringa seed | 52.2 | 4 |
| Moringa seed after 1:5 ethylacetate wash | 46.1 | 5 |
| and filtration | | |
| Moringa seed after 1:5 methanol wash, | not determined | 3 |
| followed by 1:5 ethanol wash and filtration | | |

As can be seen from the results summarized in the tables, in no case did washing with organic solvent significantly improve the taste of the Moringa seed.

### EXAMPLE 7

A series of experiments were performed in which the Moringa seed starting material was contacted a single time with an excess of room temperature tap water. The Moringa raw material comprised 45.5% protein and 12.3% fat, and was characterized by a loss on drying (LOD) of 7.4% and a protein content (dry basis) of 49.1%. The starting material was characterized by a bitterness of 4 on the scale described above.

In one experiment, 50 g of starting material were mixed with a fourfold excess of water, and the water then extracted without an additional step of washing. The final product had a bitterness level of 4 on the scale described above.

In a second experiment, 3 g of starting material were mixed with a tenfold excess of water, and the water then extracted without an additional step of washing. The final product had a bitterness level of 4 on the scale described above.

These experiments indicate that a single contact with water is insufficient, and the Moringa seed material needs to be contacted at least twice with water.

### EXAMPLE 8

A series of experiments were performed in which the same starting material used in the previous example was washed with different amounts of water at different temperatures and then dried as described above. The results are summarized in Table 3.

TABLE 3

| Moringa | Moringa/ | | | | | | | |
|---|---|---|---|---|---|---|---|---|
| starting | water ratio | | | Dry | Total | | Protein, | |
| material | first | second | contact | product, | protein, | LOD, | % w/w | |
| (g) | contact | contact | T, ° C. | g | % w/w | % w/w | dry basis | Taste |
| 50 | 1:17 | 1:9 | 40 | 21.9 | —^{a} | —^{a} | —^{a} | 1 |
| 50 | 1:16 | 1:8 | 45 | 23.9 | 30.0 | 1.8 | 30.6 | 2 |
| 50 | 1:17 | 1:9 | 26 | 20.6 | 37.1 | 2.0 | 37.9 | 1 |

^{a}not measured

The results of the experiments summarized in the table show that raising the temperature of the water used to contact the Moringa material from room temperature to 45° C. does not significantly affect the taste or the protein content of the final product, and retains some two thirds of the protein content of the starting material.

### EXAMPLE 9

A series of experiments were performed in which the procedure was performed as above, using the same starting material as in the preceding two examples, except that the second contact with water was performed using a 1:1 Moringa/water ratio. The results are summarized in Table 4.

TABLE 4

| Moringa | | | | | | | |
|---|---|---|---|---|---|---|---|
| starting | Moringa/ | | Dry | Total | | Protein, | |
| material | water ratio | contact | product, | protein, | LOD, | % w/w | |
| (g) | (first contact) | T, ° C. | g | % w/w | % w/w | dry basis | Taste |
| 50 | 1:5 | 25-26 | 23.2 | 32.9 | 0.9 | 33.2 | 3 |
| 50 | 1:5 | 26 | 24.1 | 30.0 | 1.8 | 33.3 | 3 |
| 50 | 1:4 | 23-24 | 25.1 | 30.5 | 3.1 | 31.5 | 2 |

These results show that lowering the Moringa:water ratio in the second contact does not significantly improve the protein content of the final product, but that the product formed under these conditions has a significantly more bitter taste than that made when the second contact is performed using an excess of water.

### EXAMPLE 10

A series of experiments was performed in which the contact with water was performed at high temperature. In these experiments, the water was heated prior to contact with the Moringa seed material, and the contact was performed with heating. Some of the runs were performed on a laboratory scale (˜50 g of starting material), while others were performed at a pilot industrial scale (˜1 kg of starting material). The results are summarized in Table 5.

TABLE 5

| Moringa | Moringa/ | | | | | | | |
|---|---|---|---|---|---|---|---|---|
| starting | water ratio | | | Dry | Total | | Protein, | |
| material | first | second | contact | product, | protein, | LOD, | % w/w | |
| (g) | contact | contact | T, ° C. | g | % w/w | % w/w | dry basis | Taste |
| 45^{a} | 1:4 | 1:4 | 92-98 | 23.4 | 45.0 | 4.3 | 47.0 | 0.5 |
| 1002^{b} | 1:4 | 1:4 | 88-92.5 | 611.5 | 26.5 | 3.1 | 27.3 | 1-1.5 |
| 1002^{c} | 1:4 | 1:4 | 82-91.5 | 605.6 | 23.1 | 3.2 | 23.9 | 1-1.5 |
| 1000^{d} | 1:4 | 1:4 | 89-95 | 418 | 39.9 | 4.9 | 41.9 | 1 |
| 1006^{d} | 1:4 | 1:4 | 91-93 | 478 | 40.0 | 7.1 | 43.1 | 1 |
| 1000^{d} | 1:4 | 1:4 | 90-91 | 540 | 40.2 | 5.4 | 42.5 | 1 |
| 750^{d} | 1:4 | 1:4 | 91-93 | 299 | 41.7 | 5.8 | 44.3 | 1 |
| 1000^{e} | 1:4 | 1:4 | 90-93 | 516 | 54.2 | 4.2 | 56.5 | 1-1.5 |
| 1000^{e} | 1:4 | 1:4 | 90-93 | 544 | 52.9 | 3.4 | 54.7 | 1-1.5 |
| 1000^{e} | 1:4 | 1:4 | 89 | 520 | 52.4 | 2.5 | 53.7 | 1-1.5 |
| 1000^{e} | 1:4 | 1:4 | 91-92 | 288 | 53.0 | 1.7 | 53.9 | 1-1.5 |

^{a}Starting material: Milled defatted seed cake from moringa seeds from plants grown in India; 50.1% total protein, 10.2% fat, LOD 7.3%, 54.1% total protein (dry basis); bitterness 3.5-4
^{b}Starting material: Milled defatted seed cake from moringa seeds from plants grown in India; 32.4% total protein, LOD 4.7%, 34.0% total protein (dry basis); bitterness 3.5-4
^{c}Starting material: Milled defatted seed cake from moringa seeds from plants grown in India; 30.5% total protein, LOD 4.6%, 32.0% total protein (dry basis); bitterness 3.5-4
^{d}Starting material: Milled defatted seed cake from moringa seeds from plants grown in India; 44.9% total protein, LOD 7.3%, 48.4% total protein (dry basis); bitterness 3.5-4
^{e}Starting material: Milled defatted seed cake from moringa seeds from plants grown in India; 47.2% total protein, LOD 4.6%, 49.5% protein (dry basis), 15.6% fat (3.9% saturated), 5.3% ash, 18.0% deitary fiber, 9.3% carbohydrates (3.3% total sugar); bitterness 3.5-4

The results show that that performing the contact with water under heating does not adversely affect the flavor or protein content of the final product. In addition, the results demonstrate that scaling up the process does not affect its efficiency or the quality of the final product.

### EXAMPLE 11

Experiments were performed in which both stages of contact with water were performed under acid conditions. In each case, prior to the contact with the Moringa seed material, the pH of the water was adjusted to 4.5 by addition of HCl or citric acid. The results of the experiments are summarized in Table 6.

TABLE 6

| Moringa | Moringa/ | | | | | | | |
|---|---|---|---|---|---|---|---|---|
| starting | water ratio | | | Dry | Total | | Protein, | |
| material | first | second | contact | product, | protein, | LOD, | % w/w | |
| (g) | contact | contact | T, ° C. | g | % w/w | % w/w | dry basis | Taste |
| 50^{a} | 1:4 | 1:1 | 23-24 | 20.7 | 26.5 | 3.1 | 27.3 | 1.5 |
| 50^{a} | 1:4.4 | 1:0.6 | 23-24 | 21.8 | 28.1 | 2.7 | 28.8 | 1.5-2 |
| 50^{a} | 1:16 | 1:8^{e} | 25-28 | 22.9 | 44.8 | 2.3 | 45.8 | 0-1 |
| 50^{b} | 1:4 | 1:1 | 20.7 | 19.3 | 34.1 | 3.4 | 35.3 | 2.5 |
| 50^{b} | 1:4 | 1:4 | 19.5 | 19.8 | 30.8 | 9.5 | 34.1 | 1 |
| 50^{b} | 1:4 | 1:4 | 22 | 16.7 | 34.2 | 3.1 | 35.3 | 1.5 |
| 50^{b} | 1:4 | 1:4 | 22.2 | 16.9 | 32.9 | 2.7 | 33.9 | 1.5 |
| 45^{b} | 1:4 | 1:4 | 3 | 20.1 | 39.9 | 4.4 | 41.7 | 2 |
| 45^{b} | 1:4 | 1:4 | 4 | 18.6 | 39.6 | 7.0 | 42.6 | 1.5 |
| 50^{c} | 1:4 | 1:4 | 4-14 | 19.3 | 32.1 | 1.6 | 32.6 | 1.5 |
| 50^{c} | 1:4 | 1:4 | 17-18 | 18.7 | 29.9 | 1.9 | 30.5 | 2 |
| 45^{d} | 1:4 | 1:4 | 89-97 | 17.3 | 34.6 | 6.9 | 37.2 | 2 |
| 45^{d} | 1:4 | 1:4 | 89-97 | 18.4 | 38.3 | 4.0 | 39.9 | 1-1.5 |

^{a}Starting material: Milled defatted seed cake from moringa seeds from plants grown in Israel; 45.5% total protein, 12.3% fat, LOD 7.4%, 49.1% total protein (dry basis); bitterness 4
^{b}Starting material: Milled defatted seed cake from moringa seeds from plants grown in India; 52.2% total protein, 7.5% fat, LOD 6.2%, 55.7% total protein (dry basis); bitterness 4
^{c}Starting material: Milled defatted seed cake from moringa seeds from plants grown in Israel; 38.8% total protein, 3.6% fat, LOD 8.8%, 42.6% total protein (dry basis); bitterness 5
^{d}Starting material: Milled defatted seed cake from moringa seeds from plants grown in India; 50.1% total protein, 10.2% fat, LOD 7.3%, 54.1% total protein (dry basis); bitterness 3.5-4
^{e}Second contact with water was followed by a third contact using water adjusted to a pH of 9-9.5 and a moringa/water ratio of 1:0.85

The results of these experiments indicate that performing the steps of contacting the Moringa seed material with water under acid conditions does not yield results that are significantly from those obtained when plain water (i.e. at neutral pH) is used. Both the bitterness of, and the amount of protein in, the product are similar to those of the product obtained from use of water without any adjustment of the pH.

The results of these experiments also show that the temperature of the water used to treat the Moringa seed material does not significantly affect the protein content or taste of the product.

### EXAMPLE 12

Starting material comprising 50 g of milled defatted seed cake from Moringa seeds from plants grown in India and characterized as containing 50.1% total protein, LOD 7.3%, 54.1% total protein (dry basis) was treated according to the method disclosed herein. The second contact with water was performed under basic conditions, the pH of the water used for the second contact having been adjusted to 9-9.5 prior to the contact. The second contact was performed at a temperature of 31-35° C. A 3.6 g sample of dry product was obtained from the filtrate obtained after filtration of the product of the second washing. The product was characterized as having a 24.2% total protein content, LOD 13.2% and 27.9% protein (dry basis). The product had a salty taste.

### EXAMPLE 13

In order to compare the method disclosed herein with similar methods known in the prior art, Moringa seed material was treated according to the method for extracting protein from plant material as disclosed in '041. In this method, the starting material was first contacted with aqueous base at a pH of 9, and then with aqueous acid at a pH of 4. The results are summarized in Table 7.

TABLE 7

| Moringa | Moringa/ | | | | | | | |
|---|---|---|---|---|---|---|---|---|
| starting | water ratio | | | Dry | Total | | Protein, | |
| material | first | second | contact | product, | protein, | LOD, | % w/w | |
| (g) | contact | contact | T, ° C. | g | % w/w | % w/w | dry basis | Taste |
| 50^{a} | 1:4 | 1:4 | 4-15 | 18.2 | 32.4 | 1.7 | 33.0 | 0.5-1 |
| 4000^{a} | 1:4 | 1:4 | 7-10 | 1104 | 32.7 | 4.4 | 34.2 | 1.5 |
| 50^{b} | 1:4 | 1:4 | 8-18 | 20.7 | 35.4 | 9.2 | 38.9 | 0.5 |
| 4000^{b, c} | 1:4 | 1:4 | 7-11 | 1784 | 35.2 | 3.1 | 36.3 | 0.5-1 |

^{a}Starting material: Milled defatted seed cake from moringa seeds from plants grown in Israel; 38.8% total protein, 3.6% fat, LOD 8.8%, 42.6% total protein (dry basis); bitterness 5
^{b}Starting material: Milled defatted seed cake from moringa seeds from plants grown in India; 50.1% total protein, 10.2% fat, LOD 7.3%, 54.1% total protein (dry basis); bitterness 3.5-4
^{c}Detailed analysis determined product to contain 8.0% fat, 1.5% sugars (=total carbohydrates), 49.2% dietary fiber (36.1% soluble fiber, 13.1% insoluble), and 3.0% ash

While the method of '041 did succeed in removing the bitter taste of the starting material, and yielded a final product similar in its protein content to that of the product of the method disclosed herein, it did not produce results that were significantly better than those of the method disclosed herein. That is, these results clearly demonstrate that no step of pH adjustment is necessary in a treatment of Moringa seeds that will improve their palatability while retaining the majority of their food values.

### EXAMPLE 14

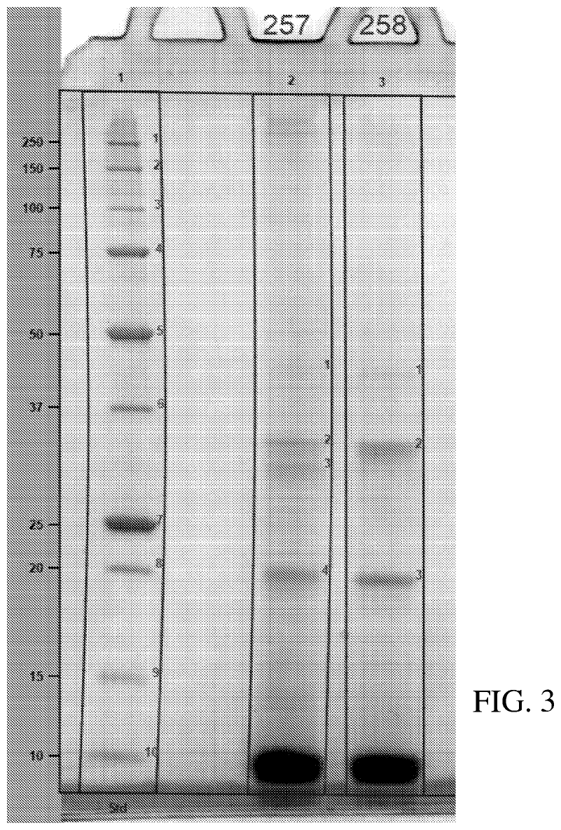

In order to compare the protein content of the Moringa seed product produced by the process disclosed herein with that of raw Moringa seeds, SDS-PAGE electrophoresis with Coomassie staining was performed on samples of raw Moringa seeds and a sample of the product of the method disclosed herein; the sample comprised 47.2% (w/w) total protein. Reference is now made to FIG. 3, which presents the results of the electrophoresis (10 μg protein per lane). The results for electrophoresis of the product of the process disclosed herein are shown in lane 2 (notated as “257” in the figure), while those for the raw Moringa seeds are shown in lane 3 (notated as “258” in the figure). The results are summarized in Table 8.

TABLE 8

| | |
|---|---|
| Raw moringa seeds | Treatment product |

| Band # | MW (kDa)^{a} | Band % | MW (kDa)^{a} | Band % |
|---|---|---|---|---|
| 1 | 43.0 ± 1.3 | 2.90 | 43.7 ± 1.3 | 2.21 |
| 2 | 32.5 ± 1.0 | 14.95 | 32.9 ± 1.0 | 7.77 |
| 3 | — | — | 30.4 ± 0.9 | 8.14 |
| 4 | 19.4 ± 0.6 | 12.94 | 19.7 ± 0.6 | 12.42 |
| 5 | 6 ± 1 | 69.21 | 6 ± 1 | 69.46 |

^{a}reported errors are estimated 1σ uncertainties

As can be seen from the electrophoresis results, the protein composition of the Moringa seed product is quite similar to that of the raw Moringa seed starting material. All of the bands present in the electrophoresis of the raw Moringa seed starting material are present in the electrophoresis of the product of the method of treatment disclosed herein, with molecular weights that are identical to within experimental error. One new band appears at 30.4±0.9 kDa; from the relative band intensities, it appears bands 2 and 3 in the electrophoresis of the treatment product represent the same protein as band 2 in electrophoresis of the raw Moringa seed. Without wishing to be bound by theory, it appears that the production process may have induced partial denaturation of a portion of the protein making up band 2 that led to a change (e.g. a conformational change) that altered its R_{f} value.

An amino acid profile of the protein content of the Moringa treatment product of Table 8 is given in Table 9.

TABLE 9

| | percent of total amino |
|---|---|
| Amino acid | add content |
| alanine | 4.95 |
| arginine | 13.46 |
| aspartic acid | 5.80 |
| cysteine + cystine | 3.90 |
| glutamic acid | 20.37 |
| glycine | 5.63 |
| histidine | 2.75 |
| isoleucine | 3.98 |
| leucine | 7.11 |
| lysine | 1.81 |
| methionine | 2.11 |
| phenylalanine | 5.50 |
| proline | 6.58 |
| serine | 3.68 |
| threonine | 3.23 |
| tryptophan | 1.53 |
| tyrosine | 2.60 |
| valine | 5.00 |

While the sample overall was enriched in protein relative to the starting material, the overall distribution of amino acids was quite similar to values reported in the literature.

1-55. (canceled)

56. A method for treating Moringa seeds, said method comprising:
obtaining a starting material comprising a material selected from the group consisting of ground Moringa seeds, ground germinated Moringa seeds, and ground fermented Moringa seeds;
contacting said starting material with a first quantity of water for a first predetermined period of time, thereby producing a soaked Moringa seed material;
separating at least partially said soaked Moringa seed material from said water;
contacting said soaked Moringa seed material with a second quantity of water for a second predetermined period of time, thereby producing debittered Moringa seed material; and, separating at least partially said debittered Moringa seed material from said water;
wherein said method does not comprise any step requiring use of organic solvent.

57. The method according to claim 56, wherein said starting material comprises ground Moringa seeds that have undergone a process to remove oil at least partially from said Moringa seeds.

58. The method according to claim 57, wherein said starting material comprises milled de-oiled Moringa seed cake.

59. The method according to claim 56, wherein at least one of the following conditions is met:
(a) said step of contacting said starting material with a first quantity of water comprises:
placing said starting material in a vessel;
adding an excess of water to said vessel; and,
allowing said starting material and said first quantity of water to remain in said vessel for said first predetermined period of time; and,
(b) said step of contacting said soaked Moringa seed material with a second quantity of water comprises:
placing said soaked Moringa seed material in a vessel;
adding an excess of water to said vessel; and,
allowing said soaked Moringa seed material and said second quantity of water to remain in said vessel for said second predetermined period of time.

60. The method according to claim 59, wherein:
said step of contacting said starting material with a first quantity of water comprises mixing or stirring said starting material and said first quantity of water during said first predetermined period of time; and,
said step of contacting said soaked Moringa seed material with said second quantity of water comprises mixing or stirring said soaked Moringa seed material and said second quantity of water during said second predetermined period of time.

61. The method according to claim 56, wherein at least one of the following conditions is met:
said first predetermined period of time is between 30 and 90 minutes; and,
second predetermined period of time is between 5 and 15 minutes.

62. The method according to claim 56, wherein at least one of the following conditions is met:
said step of contacting said starting material with a first quantity of water comprises contacting said starting material with sufficient water to provide a water:starting material weight ratio of between 3 and 20; and,
said step of contacting said soaked Moringa seed material with a second quantity of water comprises contacting said soaked Moringa seed material with sufficient water to provide a water:starting material weight ratio of between 3 and 20.

63. The method according to claim 56, wherein at least one of said steps of contacting said starting material with a first quantity of water and contacting said soaked Moringa seed material with a second quantity of water comprises contacting with water, the pH of which has been adjusted to be other than 7.

64. The method according to claim 56, wherein at least one of said steps of contacting said starting material with a first quantity of water and contacting said soaked Moringa seed material with a second quantity of water comprises contacting with water characterized by a temperature selected from the group consisting of room temperature; <10° C.; and between 85° C. and 99° C.

65. The method according to claim 56, wherein said step of separating at least partially said soaked Moringa seed material from said water is performed by a method selected from the group consisting of filtering, decanting, and centrifuging.

66. The method according to claim 56, wherein said step of contacting said soaked Moringa with said second quantity of water comprises rinsing said soaked Moringa seed material.

67. The method according to claim 66, wherein said step of rinsing said soaked Moringa seed material is preceded by a step of placing said step of placing said soaked Moringa seed material on a filter.

68. The method according to claim 56, wherein said step of separating at least partially said debittered Moringa seed material from said water is performed by a method selected from the group consisting of filtering, decanting, and centrifuging.

69. The method according to claim 56, wherein said step of separating at least partially said debittered Moringa seed material from said water is followed by a step of drying said debittered Moringa seed material.

70. The method according to claim 56, wherein said step of separating at least partially said debittered Moringa seed material from said water is followed by a step of passing said debittered Moringa seed material to an extruder.

71. The method according to claim 56, wherein said method does not comprise any step of adjusting pH.

72. The method according to claim 56, wherein said water is tap water.

73. A composition comprising Moringa seed material, said composition derived from a starting material selected from the group consisting of ground Moringa seeds, ground germinated Moringa seeds, and ground fermented Moringa seeds; said composition comprising at least 30% protein (w/w) and 18%-55% fiber,
wherein:
said composition comprises a glucomoringin concentration that is less than 30% (w/w) of that of said starting material; and,
said composition has not been produced by any process involving contact with organic solvent.

74. The composition according to claim 73, wherein said composition is characterized by at least one of the following characteristics:
said composition has a glucomoringin concentration that is less than 5% (w/w) of that of said starting material;
said composition has a glucosinolate concentration that is less than 30% (w/w) of that of said starting material;
said composition comprises at least 40% protein;
said composition comprises 30-60% (w/w) protein;
said composition comprises 20-60% (w/w) protein (dry basis);
said composition comprises 0.5-16% (w/w) fat;
said composition comprises 15-40% (w/w) soluble fiber;
said composition comprises 0.5-3.5% (w/w) sugar;
said composition comprises 2-3% (w/w) ash; and,
said composition is characterized by a loss on drying of 1-10% (w/w).

75. The composition according to claim 73, wherein said composition is characterized by a characteristic selected from the group consisting of:
said composition comprises proteins having molecular weights, as determined by SDS-PAGE electrophoresis with Coomassie staining, of 43.7±1.3 kDa, 32.9±1.0 kDa, 30.4±0.9 kDa, 19.7±0.5 kDa, and 6±1 kDa;
said composition comprises proteins having molecular weights, as determined by SDS-PAGE electrophoresis with Coomassie staining, of 43.7±1.3 kDa, 32.9±1.0 kDa, 30.4±0.9 kDa, 19.7±0.5 kDa, and 6±1 kDa; and,
said composition comprises proteins having molecular weights identical to within one standard deviation of molecular weights of proteins of said starting material, as determined by SDS-PAGE electrophoresis with Coomassie staining.
